(19) United States
(12) Patent Application Publication
(10) Pub. No.: US 2016/0062613 A1
(43) Pub. Date: Mar. 3, 2016

(54) ELECTRONIC DEVICE FOR COPYING AND PASTING OBJECTS AND METHOD THEREOF

(71) Applicant: Chiun Mai Communication Systems, Inc., New Taipei (TW)

(72) Inventor: KE-HAN LEE, New Taipei (TW)

(21) Appl. No.: 14/841,733

(22) Filed: Sep. 1, 2015

(30) Foreign Application Priority Data
Sep. 1, 2014 (CN) 201410441188.3

(51) Int. Cl. G06F 3/0484; G06F 3/0486; G06F 3/0482; G06F 3/0488; G06F 9/54

(52) U.S. Cl. CPC G06F 3/04842; G06F 3/0488; G06F 9/543; G06F 3/0482; G06F 3/0486

(57) ABSTRACT

A method for copying and pasting an object displayed on a display of an electronic device includes receiving an invoking signal for copying the object, initiating a copy and paste function upon receiving the invoking signal, selecting the object to be copied when the copy and paste function is initiated, creating a window after the object is selected and displaying the window containing the selected object on the display, and moving the window containing the selected object to paste the selected object. The window remains displayed on the display when a current interface is changed for another interface.

### FIELD

The present disclosure relates to copying and pasting methods, and particularly to a method for copying and pasting objects among different interfaces.

### BACKGROUND

Generally when copying and pasting objects within applications, an object to be copied is selected, and then the object can be pasted to an input field.

### BRIEF DESCRIPTION OF THE DRAWINGS

Implementations of the present technology will now be described, by way of example only, with reference to the attached figures.

FIG. 1 is a block diagram of an embodiment of an electronic device.

FIG. 2 is a diagrammatic view of a copy and paste function of the electronic device.

FIG. 3 is a diagrammatic view of a window containing a selected object to be pasted.

FIG. 4 is a diagrammatic view of a plurality of receiving locations for pasting the selected object to and an input field of a current interface.

FIG. 5 is a flowchart of an embodiment of a method for copying and pasting an object.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

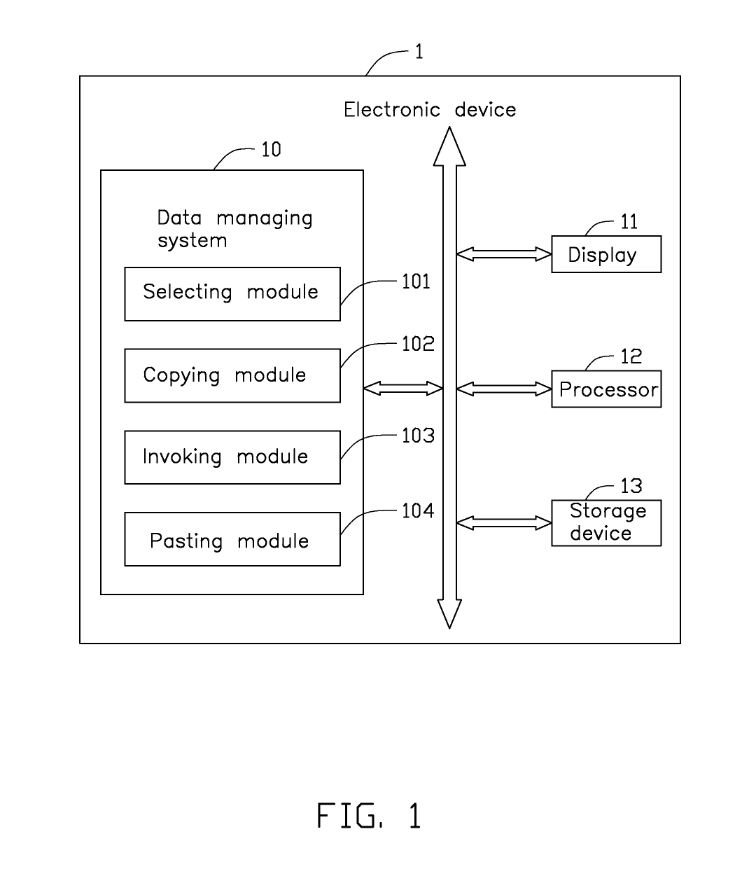

FIG. 1 illustrates an embodiment of an electronic device 1 implementing a data managing system 10 for copying and pasting an object. The object can be text, an image, or the like. The electronic device 1 can include a display 11, a processor 12, and a storage device 13. The display 11 can receive touch input from an input means, such as a finger of a user, a stylus, or a touch input device. The object is displayed by the display 11. In at least one embodiment, the display 11 is a touch display and is made of carbon nanotubes capable of sensing a pressure value of the touch input applied thereon.

In at least one embodiment, the data managing system 10 can include a plurality of modules, such as a selecting module 101, a copying module 102, an invoking module 103, and a pasting module 104. The modules 101-104 can include one or more software programs in the form of computerized codes stored in the storage device 13. The computerized codes can include instructions executed by the processor 12 to provide functions for the modules 101-104.

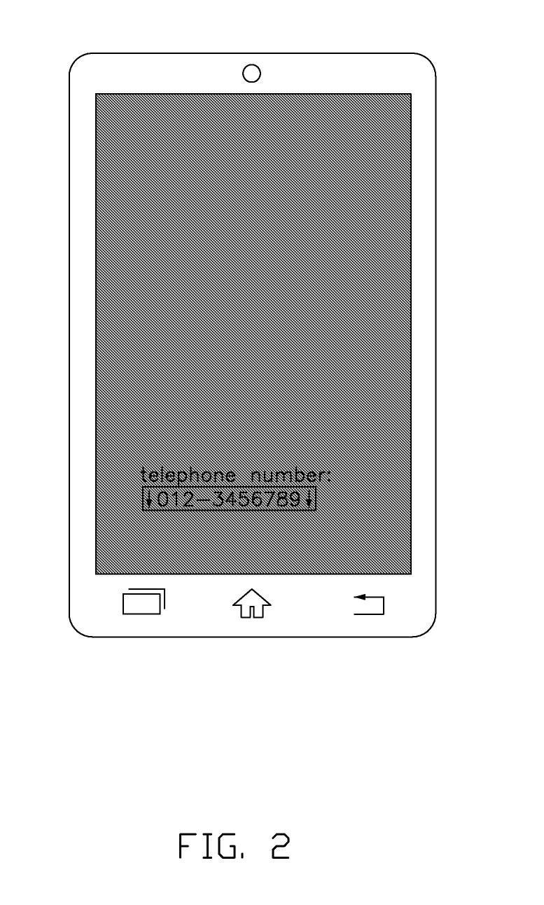

The selecting module 101 can detect an invoking signal and initiate a copy and paste function in response to the detected invoking signal. In at least one embodiment, the invoking signal is touch input applied on the display 11 when a pressure value of the touch input is greater than a threshold pressure value. In other embodiments, the invoking signal can be generated by pressing a button of the electronic device 1, applying a predetermined touch gesture on the display 11, or the like. As illustrated in FIG. 2, the copy and paste function can be a selection box surrounding the object. A size of the selection box can be adjusted by user input to select the object. In at least one embodiment, the selecting module 101 can adjust one or more display parameters of the display 11 when the copy and paste function is initiated to indicate that the object can be selected. For example, as illustrated in FIG. 2, a brightness of the display 11 can be adjusted from a normal level to a reduced level to indicate that the copy and paste function is initiated. In the illustrated embodiment, the object is a phone number.

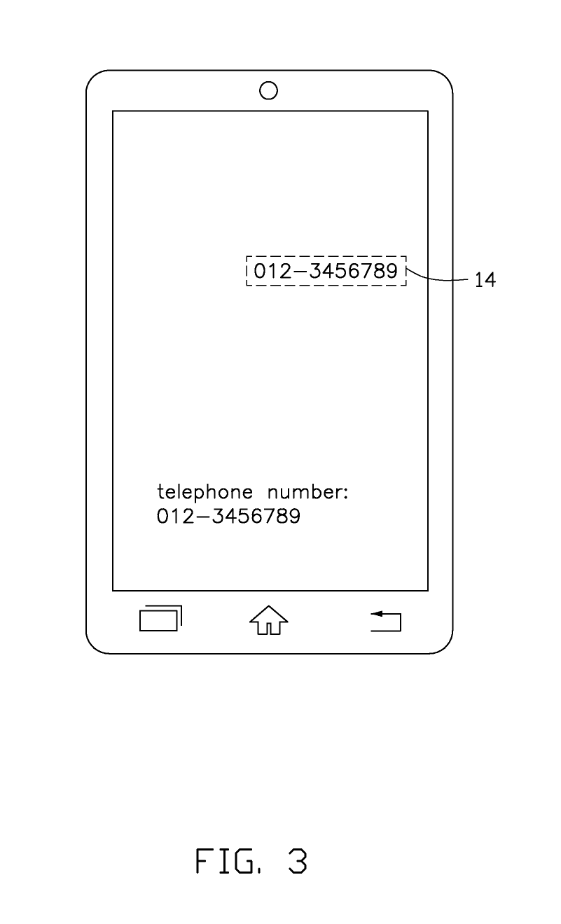

Referring to FIG. 3, the copying module 102 can copy the selected object. In at least one embodiment, the selected object can be copied when the input means drags the selected object along the display 11. In detail, the copying module 102 creates a window 14 and moves the window 14 from a point of the display 11 corresponding to the selected object to a point of the display not corresponding to the selected object when the input means touches the display 11 and moves from the point of the display 11 corresponding to the selected object to the point of the display not corresponding to the selected object, and the copying module 102 displays the window 14 containing the selected object. When the window 14 is created, the copying module 102 can further adjust the one or more parameters of the display 11 back to indicate that the copy and paste function is ended. For example, the copying module 102 returns the brightness of the display 11 back to the normal level. The window 14 containing the selected object can remain displayed in place on the display 11 even when the interface is changed.

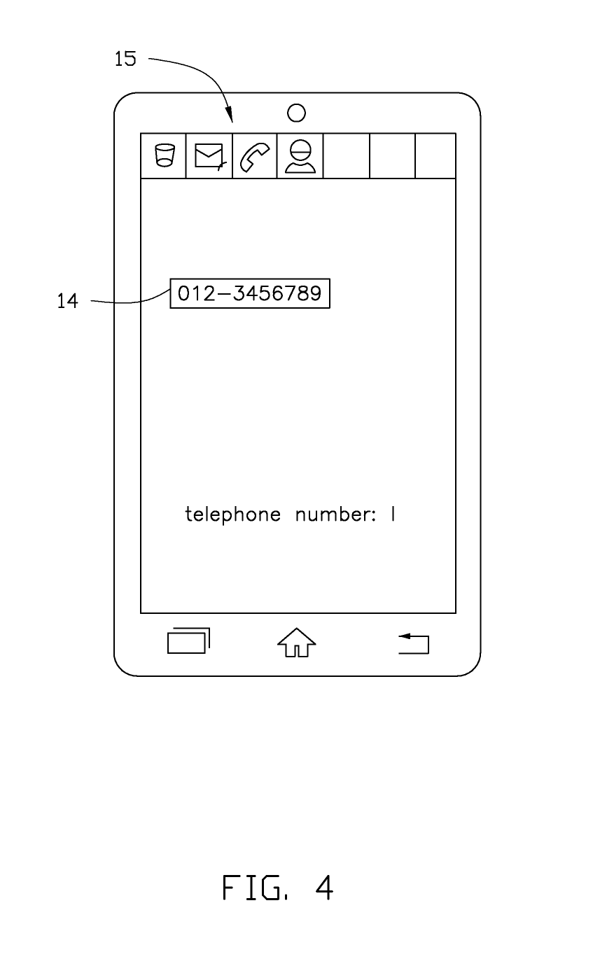

The window 14 containing the selected object can be further moved by the copying module 102 according to a movement of the input means on the display 11. As illustrated in FIG. 4, when the window 14 is dragged by the input means (that is, moved by the copying module 102), the invoking module 103 can display a plurality of receiving locations 15. When the window 14 is dragged to and released by the input means on any one of the receiving locations 15, the selected object in the window 14 can be pasted to a corresponding input field of the corresponding receiving location 15. For example, each of the receiving locations 15 is an icon of a corresponding application of the electronic device 1. The plurality of receiving locations 15 can correspond in type to the selected object. For example, when the selected object is text, the plurality of receiving locations 15 can be applications that can receive text input. In the illustrated embodiment, the plurality of receiving locations 15 is a plurality of applications that can receive a phone number. In at least one embodiment, the applications can be automatically opened and implement corresponding functions when the selected object is pasted to the corresponding input field of the receiving location 15. For example, when the selected object is a phone number and is pasted to the corresponding input field of a phone application, the phone application can automatically dial the phone number. In at least one embodiment, when the window 14 is being dragged by the input means, the window 14 can be changed from being transparent to being non-transparent to indicate that the window 14 is being dragged. When the selected object is pasted to the input field of the receiving location, the window 14 can be removed from the display 11.

The selected object can also be pasted to a corresponding input field I of the currently displayed interface. In detail, the pasting module 104 detects a coordinate position of the window 14 containing the selected object when the window 14 is not released on one of the receiving locations and determines whether the coordinate position of the window 14 when the window 14 is released by the input means is within a predetermined distance of the input field I. When it is determined that the window 14 is released within the predetermined distance of the input field I, then the pasting module 104 pastes the selected object to the input field I. When the selected object is pasted to the input field I, the window 14 can be removed from the display 11. In at least one embodiment, the predetermined distance is 0.5 centimeters (cm). When the window 14 is released by the input means neither on one of the receiving locations or within the predetermined distance of the input field I, the window 14 remains displayed in place on the display 11.

In at least one embodiment, a plurality of objects of the current interface or of separate interfaces can be copied and pasted. In detail, the copying module 102 determines whether another invoking signal is received after creating the window 14 containing the selected object. When another invoking signal is received, the selecting module 101 selects another object in response to user input, and the copying module 102 creates another window 14 containing the corresponding selected object. Thus, a plurality of windows 14 containing corresponding selected objects can be displayed in place on the display 11 and pasted to corresponding receiving locations or corresponding input fields I.

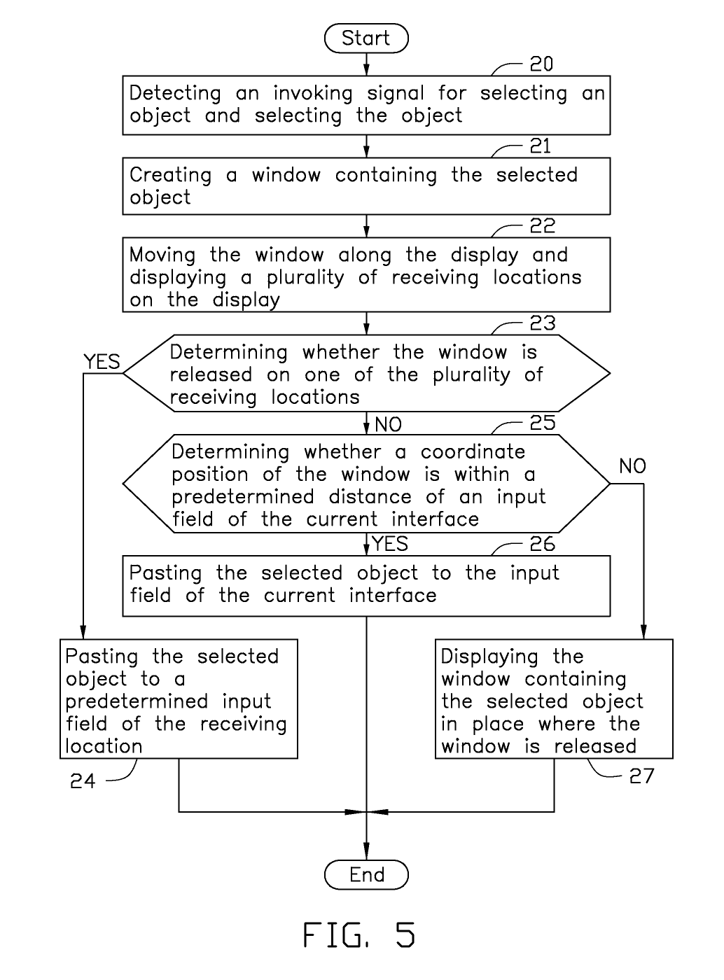

FIG. 5 illustrates a flowchart of an exemplary method for copying and pasting an object on an electronic device. The example method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Additionally, the illustrated order of blocks is by example only, and the order of the blocks can be changed. The example method can begin at block 20.

At block 20, the electronic device can detect an invoking signal for selecting an object and select the object in response to user input. In detail, the electronic device can initiate a copy and paste function in response to detecting the invoking signal. In at least one embodiment, the invoking signal is touch input applied on a display when a pressure value of the touch input is greater than a threshold pressure value. In other embodiments, the invoking signal can be generated by pressing a button of the electronic device, applying a predetermined touch gesture on the display, or the like. The copy and paste function can be a selection box surrounding the object. A size of the selection box can be adjusted by user input to select the object.

At block 21, the electronic device can create a window containing the selected object and move the window to copy the object. In at least one embodiment, the selected object can be copied when the input means drags the selected object along the display. In detail, the window is created and moved from a point of the display corresponding to the selected object to another point of the display not corresponding to the selected object when the input means touches the display and moves from the point of the display corresponding to the selected object to the point of the display not corresponding to the selected object, and the window is displayed in place containing the selected object.

At block 22, the electronic device can move the window along the display according to a movement of the input means on the display and display a plurality of receiving locations on the display. For example, each of the receiving locations is an icon of a corresponding application of the electronic device. The plurality of receiving locations can correspond in type to the selected object. For example, when the selected object is text, the plurality of receiving locations can be applications that can receive text input.

At block 23, the electronic device can determine whether the window is released on one of the plurality of receiving locations. When the window is released on one of the plurality of receiving locations, block 24 is implemented. Otherwise, when the window is released in a position outside of the receiving locations, block 25 is implemented.

At block 24, the selected object can be pasted to a predetermined input field of the corresponding receiving location by being dragged to and released by the input means on the corresponding receiving location.

At block 25, the electronic device can determine whether a coordinate position of the window is within a predetermined distance of an input field of the current interface being displayed on the display. When the window is released within the predetermined distance of the input field of the current interface being display, block 26 is implemented. Otherwise, when the window is released outside of the predetermined distance, block 27 is implemented.

At block 26, the selected object is pasted to the input field of the current interface.

At block 27, the window containing the selected object continues to be displayed in place where the window was released.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for copying and pasting an object displayed on a display of an electronic device, the method comprising:
receiving, by the electronic device, an invoking signal for copying the object;
initiating, by the electronic device, a copy and paste function upon receiving the invoking signal;
selecting, by the electronic device in response to an input means, the object to be copied when the copy and paste function is initiated;
creating, by the electronic device, a window after the object is selected and displaying the window containing the selected object on the display; and
moving, by the electronic device in response to the input means, the window containing the selected object to paste the selected object.

2. The method as in claim 1, wherein the invoking signal is touch input applied on the display when the touch input has a pressure value greater than a threshold pressure.

3. The method as in claim 1, wherein:
the window containing the selected object is transparent;
when the copy and paste function is initiated, one or more display parameters of the display are changed;
when the window containing the selected object is created, the one or more display parameters of the display are changed back to indicate that the copy and paste function is ended; and
when the window containing the selected object is dragged, the window is changed to be non-transparent.

4. The method as in claim 1, wherein the window is created and moved from a point of the display corresponding to the selected object to another point of the display not corresponding to the selected object.

5. The method as in claim 4, wherein:
the electronic device detects whether the window containing the selected object is moved;
when the electronic device detects that the window containing the selected object is moved, the electronic device displays a plurality of receiving locations on the display, and each receiving location corresponds to a different interface;
at least one of the plurality of receiving locations displayed on the display corresponds to a type of the selected object for receiving the selected object; and
when the window containing the selected object is moved to one of the plurality of receiving locations, the selected object is pasted to a predetermined input field of the corresponding interface.

6. The method as in claim 5, wherein:
a plurality of objects is selectable from a same interface or from different interfaces;
each selected object is contained in a corresponding window; and
the windows containing the selected objects remain displayed in place on the display when the interfaces are changed on the display.

7. An electronic device implementing a data managing system for copying and pasting an object, the electronic device comprising:
a display configured to display at least one interface thereon and receive touch input from an input means;
a storage device configured to store a plurality of instructions of a plurality of modules of the data managing system; and
a processor configured to execute the instructions of the plurality of modules;
wherein when an invoking signal is received, the data managing system initiates a copy and paste function for selecting an object of the interface displayed on the display;
wherein when the object is selected by the input means, the data managing system creates a window and displays the window containing the selected object on the display;
wherein when the window containing the selected object is dragged by the input means along the display, the data managing system displays at least one receiving location on the display, the receiving location corresponding to a type of the selected object; and
wherein when the window containing the selected object is dragged to the receiving location, the data managing system pastes the selected object to a predetermined input field of the corresponding receiving location.

8. The electronic device as in claim 7, wherein when the interface is changed to another interface, the window containing the selected object remains displayed in place on the display.

9. The electronic device as in claim 7, wherein the display is a touch display and made of carbon nanotubes that sense pressure of touch input applied on the display by the input means.

10. The electronic device as in claim 7, wherein the plurality of modules of the data managing system comprises:
a selecting module configured to detect the invoking signal and initiate the copy and paste function in response to the detected invoking signal, wherein the invoking signal is touch input applied on the display when a pressure value of the touch input is greater than a threshold pressure value;
a copying module configured to create the window and display the window containing the selected object on the display;
an invoking module configured to display the receiving location on the display; and
a pasting module configured to detect a coordinate position of the window containing the selected object when the window is not released by the input means on one of the plurality of receiving locations, determine whether the coordinate position of the window is within a predetermined distance of an input field of the current interface, display the window in place on the display when it is determined that the coordinate position of the window is not within the predetermined distance of the input field, and paste the selected object to the input field when it is determined that the coordinate position of the window is within the predetermined distance of the input field.

11. The electronic device as in claim 10, wherein:
the window containing the selected object is transparent;
when the copy and paste function is initiated, the selecting module changes one or more display parameters of the display;
when the window containing the selected object is created, the copying module changes the one or more display parameters of the display back to indicate that the copy and paste function is ended; and
when the window containing the selected object is dragged, the invoking module changes the window to be non-transparent to indicate that the window containing the selected object is being dragged..

12. The electronic device as in claim 11, wherein:
when the selected object is pasted to the input field of the current interface, the window is removed from the display; and
when the window is displayed in place after being dragged by the input means, the window is changed back to being transparent.

13. The electronic device as in claim 10, wherein:
after creating the window containing the selected object, the copying module further determines whether another invoking signal is received;
a plurality of objects is selectable from a same interface or from different interfaces;
the selecting module selects each object in response to user input;
each selected object is contained in a corresponding window; and
the windows containing the selected objects remain displayed in place on the display when the interfaces are changed on the display.
